(19) United States
(12) Patent Application Publication
(10) Pub. No.: US 2025/0183401 A1
(43) Pub. Date: Jun. 5, 2025

(54) STORAGE CONTAINER SUPPORT ASSEMBLY

(71) Applicants: Hyundai Motor Company, Seoul (KR); Kia Corporation, Seoul (KR)

(72) Inventor: Yeon Man Jeong, Yongin-si (KR)

(21) Appl. No.: 18/920,177

(22) Filed: Oct. 18, 2024

(30) Foreign Application Priority Data
Dec. 4, 2023 (KR) 10-2023-0173610

(51) Int. Cl. H01M 10/613; H01M 10/6568; H01M 50/233

(52) U.S. Cl. CPC H01M 10/613; H01M 10/6568; H01M 50/233

(57) ABSTRACT

An embodiment battery housing includes a base plate disposed on a lower side of a battery module and configured to support the battery module and a support member supported by the base plate to define an accommodation space for accommodating the battery module and defining a cooling water channel in which cooling water configured to cool the battery module flows in an interior thereof, wherein the cooling water channel includes a first cooling water channel communicated with an introduction hole through which the cooling water flows into the support member and a second cooling water channel communicated with a discharge hole through which the cooling water flowing in the first cooling water channel is discharged from the support member after circulating, wherein the second cooling water channel is disposed on an upper side of the first cooling water channel.

### CROSS-REFERENCE TO RELATED APPLICATIONS

This application claims the benefit of Korean Patent Application No. 10-2023-0173610, filed on Dec. 4, 2023, which application is hereby incorporated herein by reference.

### TECHNICAL FIELD

The present disclosure relates to a battery housing.

### BACKGROUND

Recently, as awareness of the crisis over the environment and depletion of oil resources has increased, research and developments on electric vehicles that are eco-friendly vehicles have been highlighted. The electric vehicles include plug-in hybrid electric vehicles (PHEVs), battery electric vehicles (BEVs), and fuel cell electric vehicles (FCEVs).

An electric vehicle may include a battery module and a battery housing that supports the battery module. Meanwhile, an electric vehicle uses battery cells of a battery module as a power source, and cooling water channels may be provided in an interior of the battery housing to prevent the temperatures of the battery cells from increasing.

Generally, the cooling water channels are sometimes disposed on a lower side of the battery module, and according to this structure, the cooling water channels may be greatly influenced by external temperature, and thus, cooling effects may be relatively small.

Accordingly, a need for a battery housing with an improved structure for cooling the battery module is increasing.

### SUMMARY

Embodiments of the present disclosure can solve problems occurring in the prior art while advantages achieved by the prior art are maintained intact.

An embodiment of the present disclosure provides a battery housing having cooling water channels that are configured to cool a battery module in an interior of a support member disposed on a side of the battery module.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery housing includes a base plate disposed on a lower side of a battery module and that supports the battery module and a support member supported by the base plate to define an accommodation space for accommodating the battery module and defining a cooling water channel, in which cooling water that cools the battery module flows, in an interior thereof, and the cooling water channel includes a first cooling water channel communicated with an introduction hole, through which the cooling water flows into the support member, and a second cooling water channel communicated with a discharge hole, through which the cooling water flowing in the first cooling water channel is discharged from the support member after circulating, the second cooling water channel is disposed on an upper side of the first cooling water channel.

The support member may include a partition wall that separates the first cooling water channel and the second cooling water channel.

The partition wall may extend in parallel to a horizontal direction between an upper end of the support member and a lower end of the support member.

The support member may include a manifold block defining the introduction hole and the discharge hole and extending in a first direction and a side support member connected to the manifold block and extending in a second direction perpendicular to the first direction.

The first cooling water channel may include an introduced cooling water channel defined by the manifold block and a first circulating cooling water channel communicated with the introduced cooling water channel and defined by the side support member. The second cooling water channel may include a discharged cooling water channel defined by the manifold block and a second circulating cooling water channel communicated with the first circulating cooling water channel and defined by the side support member.

The partition wall may include a manifold partition wall disposed in an interior of the manifold block and extending in the first direction and a side partition wall disposed in an interior of the side support member and extending in the second direction.

The side support member may define a circulation hole disposed at a second end opposite a first end of the side partition wall connected to the manifold block, the circulation hole connecting the first cooling water channel and the second cooling water channel.

The battery housing may further include an end member disposed in parallel to the manifold block, connected to the side support member, and facing the manifold block in a state in which the side support member is interposed therebetween.

The side partition wall may include a first end connected to the manifold block and a second end opposite the first end, the second end being spaced apart from the end member and defining the circulation hole together with the end member.

The second end of the side partition wall may have a shape recessed toward the manifold block.

The battery housing may further include a partition member supported by the base plate and extending in the first direction to cross the side support member so as to define the accommodation space.

According to an embodiment of the present disclosure, a battery housing includes a base plate disposed on a lower side of a battery module and configured to support the battery module and a support member. The support member includes a partition wall, a manifold block extending in a first direction and defining an introduction hole and a discharge hole disposed on a first surface, the manifold block comprising a first distribution hole disposed on a second surface opposite the first surface and a second distribution hole and a side support member connected to the manifold block and extending in a second direction perpendicular to the first direction, wherein the support member is supported by the base plate to define an accommodation space for accommodating the battery module and defining a cooling water channel in which cooling water configured to cool the battery module flows in an interior thereof. The cooling water channel includes a first cooling water channel communicated with the introduction hole through which the cooling water flows into the support member, the first cooling water channel comprising an introduced cooling water channel defined by the manifold block and a first circulating cooling water channel communicated with the introduced cooling water channel and defined by the side support member, wherein the first distribution hole communicates the introduced cooling water channel and the first circulating cooling water channel and a second cooling water channel disposed on an upper side of the first cooling water channel and communicated with the discharge hole through which the cooling water flowing in the first cooling water channel is discharged from the support member after circulating, the second cooling water channel comprising a discharged cooling water channel defined by the manifold block and a second circulating cooling water channel communicated with the first circulating cooling water channel and defined by the side support member, wherein the second distribution hole communicates the discharged cooling water channel and the second circulating cooling water channel, and wherein the partition wall separates the first cooling water channel and the second cooling water channel.

The first distribution hole may be provided in plural and the second distribution hole may be provided in plural. Sizes of cross-sections of the plurality of first distribution holes that are perpendicular to a direction in which the cooling water flows may be progressively smaller as they approach the introduction hole and sizes of cross-sections of the plurality of second distribution holes that are perpendicular to the direction in which the cooling water flows may be progressively smaller as they approach the discharge hole.

The partition wall may include a manifold partition wall disposed in an interior of the manifold block and extending in the first direction and a side partition wall disposed in an interior of the side support member and extending in the second direction.

The first circulating cooling water channel may include a (1-1)-th circulating cooling water channel and a (1-2)-th circulating cooling water channel distinguished from the (1-1)-th circulating cooling water channel. The second cooling water channel may include a (2-1)-th circulating cooling water channel and a (2-2)-th circulating cooling water channel distinguished from the (2-1)-th circulating cooling water channel.

The side support member may further include a first guide partition wall that is parallel to, and spaced apart from, the side partition wall to separate the (1-1)-th circulating cooling water channel and the (1-2)-th circulating cooling water and a second guide partition wall that is parallel to, and spaced apart from, the side partition wall to separate the (2-1)-th circulating cooling water channel and the (2-2)-th circulating cooling water channel.

The battery housing may further include an end member disposed in parallel to the manifold block, connected to the side support member and that faces the manifold block in a state in which the side support member is interposed therebetween.

A first distance between the second guide partition wall and the end member may be greater than a second distance between the first guide partition wall and the end member or a distance between the side partition wall and the end member.

A first distance between the second guide partition wall and the end member may be greater than a second distance between the side partition wall and the end member.

A first distance between the first guide partition wall and the end member may be formed to correspond to a second distance between the side partition wall and the end member.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a perspective view of a battery housing according to an embodiment of the present disclosure;

FIG. 2 is a schematic view illustrating a flow of cooling water that flows through a battery housing according to an embodiment of the present disclosure;

FIG. 3 is an enlarged view of a manifold block of a battery housing and surrounding components according to an embodiment of the present disclosure;

FIG. 4 is a vertical cross-sectional view of a manifold block and surrounding components according to an embodiment of the present disclosure;

FIG. 5 is a diagram illustrating a distribution hole that is provided on a rear surface of a manifold block according to an embodiment of the present disclosure;

FIG. 6 is a cross-sectional view illustrating an introduced cooling water channel, a discharged cooling water channel, and a plurality of distribution holes of a manifold block according to an embodiment of the present disclosure;

FIG. 7 is a perspective view illustrating a vertical cross-section of a fifth side support member according to an embodiment of the present disclosure;

FIG. 8 is an enlarged view of portion “B” illustrated in FIG. 7; and

FIG. 9 is a schematic view illustrating a flow of cooling water that flows through a battery housing according to another embodiment of the present disclosure.

### DETAILED DESCRIPTION OF ILLUSTRATIVE EMBODIMENTS

Hereinafter, preferred embodiments of the present disclosure will be described in detail with reference to the attached drawings so that those skilled in the art may easily implement the present disclosure. The following description is one of several aspects of the embodiments, and in describing one embodiment, detailed descriptions of known functions or configurations are omitted to clarify the gist of the embodiments of the present disclosure.

Furthermore, in describing the components of the embodiments of the present disclosure, terms such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art to which the present disclosure pertains. The terms, such as the terms defined in dictionaries, which are generally used, should be construed to coincide with the context meanings of the related technologies, and they are not to be construed as having ideal or excessively formal meanings unless explicitly defined in the present disclosure.

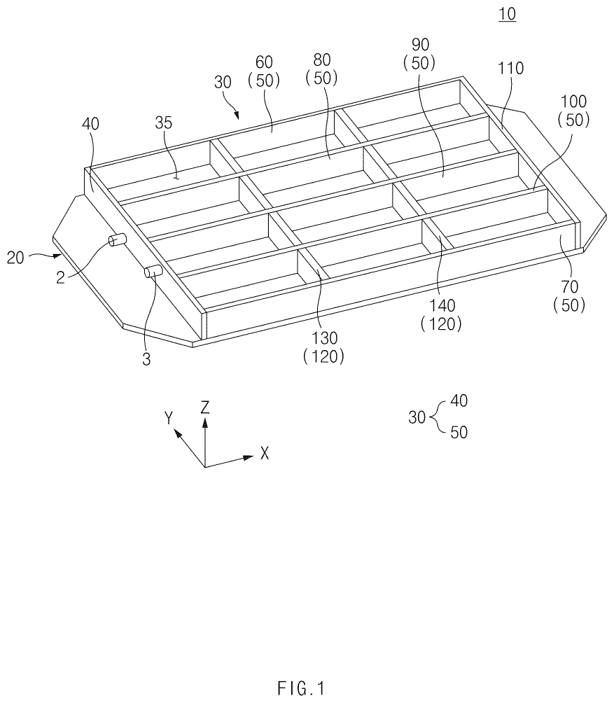

Hereinafter, embodiments of the present disclosure will be described in detail with reference to FIGS. 1 to 9.

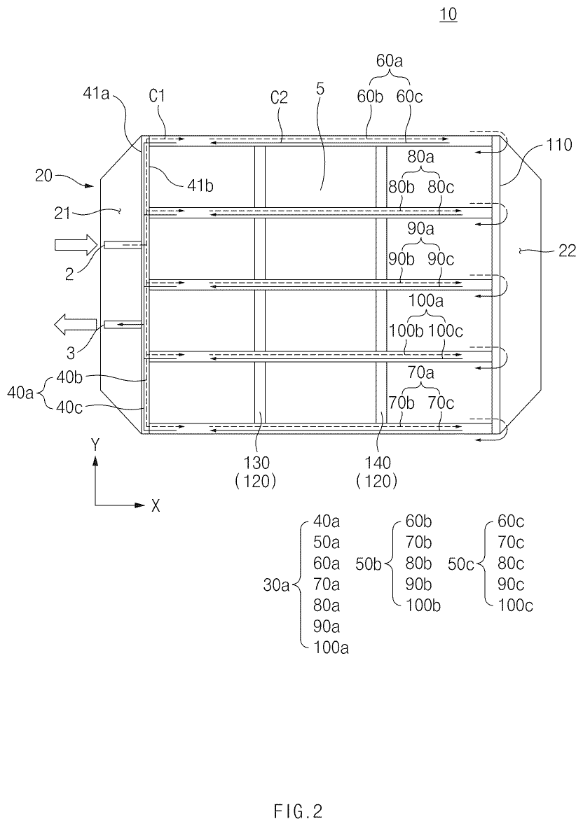

FIG. 1 is a perspective view of a battery housing according to an embodiment of the present disclosure. FIG. 2 is a schematic view illustrating a flow of cooling water that flows through the battery housing according to an embodiment of the present disclosure.

Referring to FIGS. 1 and 2, a battery housing 10 may be understood as a component that is mounted in an interior of an electric vehicle as a part of a battery pack system. The battery pack system may include a battery module 5 and a battery housing 10 that is formed to surround the battery module 5.

The battery module 5 may include a plurality of battery cells. The battery cells may be lithium-ion batteries, but the embodiments of the present disclosure are not limited thereto. The plurality of battery cells may be used in the form of the battery module 5 to be protected from an impact, heat, and vibration from an outside.

The battery housing 10 may include a base plate 20 that is disposed on a lower side of the battery module 5 and supports the battery module 5, a support member 30 that is supported by the base plate 20, and an end member 110. As will be described later, according to embodiments of the present disclosure, a channel in which cooling water flows may be formed in an interior of the support member 30, and such a channel may not be formed in the end member 110.

The support member 30 and the end member 110 may be supported by the base plate 20 and may extend in a grid pattern to form a plurality of accommodation spaces 35 for accommodating a plurality of battery modules 5.

Meanwhile, the battery housing 10 may need a structure for cooling the plurality of battery modules 5. According to an embodiment of the present disclosure, the support member 30 may form a cooling water channel 30a, in which the cooling water that is configured to cool the battery module 5 flows, in the interior of the support member 30.

The support member 30 may include a manifold block 40 that is disposed on a front side of the plurality of battery modules 5, which is opposite to the “X” direction and extends in a first direction (the “Y” direction), and a side support member 50 that is coupled to the manifold block 40 and extends in a second direction (the “X” direction) that is perpendicular to the manifold block 40.

The side support member 50 may include a first side support member 60 and a second side support member 70, which are disposed in parallel to each other, and a third side support member 80, a fourth side support member 90, and a fifth side support member 100, which are disposed between the first side support member 60 and the second side support member 70.

The first to fifth side support members 60, 70, 80, 90, and 100 are all disposed in parallel to each other in the second direction (the “X” direction) that is perpendicular to the first direction (the “Y” direction), and one side thereof may be connected to the manifold block 40, and an opposite side thereof may be connected to the end member 110.

The first side support member 60 and the second side support member 70 may be understood as components of an outer wall for protecting an outside of the plurality of battery modules 5, and the third to fifth side support members 70 to 90 may be understood as components of an inner wall for supporting one surface of each of the battery modules 5.

The end member 110 may be disposed in parallel to the manifold block 40. A cooling water channel 30a may not be provided in an interior of the end member 110. The end member 110 may be disposed in parallel to the manifold block 40, may be connected to the side support member 50, and may be configured to face the manifold block 40 while the side support member 50 is interposed therebetween.

Electric part accommodating parts 21 and 22 for electric parts (not illustrated) for controlling the battery module 5 may be provided on a front side (an opposite direction to the “X” direction) of the manifold block 40 or a rear side (the “X” direction) of the end member 110.

The manifold block 40 may cover a front side (an opposite direction to the “X” direction) of the plurality of battery modules 5, and the end member 110 may cover a rear side (the “X” direction) of the plurality of battery modules 5.

Furthermore, the first side support member 60 may cover a right side (the “Y” direction) of the plurality of battery modules 5, and the second side support member 70 may cover a left side (an opposite direction to the “Y” direction) of the plurality of battery modules 5.

That is, each of the manifold block 40, the first side support member 60, the second side support member 70, and the end member 110 may be understood as an outer wall that surrounds the plurality of battery modules 5 to protect the plurality of battery modules 5.

A partition member 120 that is disposed in parallel to the manifold block 40 or the end member 110 may be provided between the manifold block 40 and the end member 110. The partition member 120 may be supported by the base plate 20 and may extend in the first direction (the “Y” direction) to cross the side support member 50 to define an accommodation space 35.

The partition member 120 may support one surface of each battery module 5. The partition member 120 may include several members, and each member may be disposed between adjacent side support members 50.

The partition member 120 may include a first partition member 130 that extends in parallel to the manifold block 40 to define the accommodation space 35 together with the manifold block 40 and a second partition member 140 that is disposed between the first partition member 130b and the end member 110 and extends in parallel to the end member 110.

Meanwhile, the cooling water configured to cool the battery module 5 may be introduced into the cooling water channel 30a through an introduction pipe 2 that is coupled through a front surface 41a of the manifold block 40 and then may be discharged from the cooling water channel 30a through the discharge pipe 3 that is coupled through the front surface 41a of the manifold block 40.

The cooling water channel 30a may include a manifold channel 40a that is defined by the manifold block 40 and side channels 50a that have first to fifth side channels 60a, 70a, 80a, 90a, and 100a that are communicated with the manifold channel 40a and are formed in interiors of the side support members 50. The manifold channel 40a and the side channels 50a may define cooling water channels 30a in which the cooling water flows.

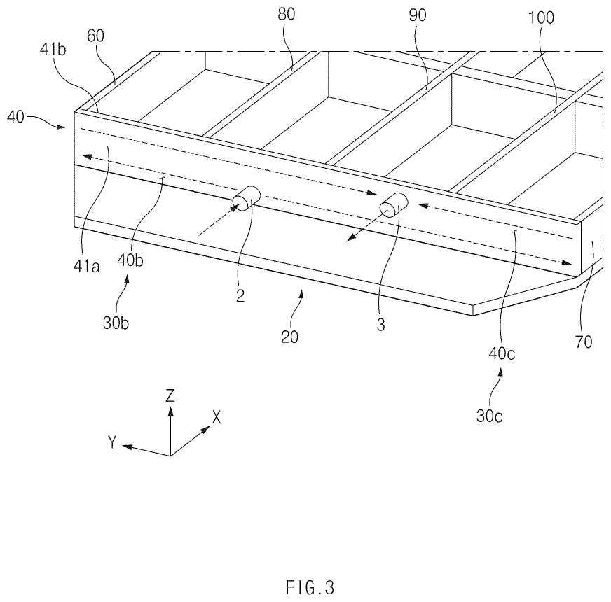

The cooling water channel 30a may include a first cooling water channel 30b (see FIG. 3) that is communicated with the introduction pipe 2 and a second cooling water channel 30c in which the cooling water flows toward the discharge pipe 3 after circulating from the first cooling water channel 30b.

The manifold channel 40a may include an introduced cooling water channel 40b that is a part of the first cooling water channel 30b and a discharged cooling water channel 40c that is a part of the second cooling water channel 30c. Each of the side channels 50a may include a first circulating cooling water channel 50b that is communicated with the introduced cooling water channel 40b such that the cooling water is distributed from the introduced cooling water channel 40b and a second circulating cooling water channel 50c that is communicated with the discharged cooling water channel 40b such that the cooling water is collected in the discharged cooling water channel 40b.

That is, the first cooling water channel 30b may include an introduced cooling water channel 40b defined by the manifold block 40 and a first circulating cooling water channel 50b that is communicated with the introduced cooling water channel 40b and is defined by each side support member 50.

The second cooling water channel 30c may include the discharged cooling water channel 40c defined by the manifold block 40 and a second circulating cooling water channel 50c that is communicated with the first circulating cooling water channel 50b and is defined by each side support member 50. The second circulating cooling water channel 50c may be communicated with the discharged cooling water channel 40c.

The first circulating cooling water channel 50b may include a (1-1)-th side channel 60b that is formed in an interior of the first side support member 60, a (2-1)-th side channel 70b that is formed in an interior of the second side support member 70, a (3-1)-th side channel 80b that is formed in an interior of the third side support member 80, a (4-1)-th side channel 90b that is formed in an interior of the fourth side support member 90, and a (5-1)-th side channel 100b that is formed in an interior of the fifth side support member 100.

The second circulating cooling water channel 50c may include a (1-2)-th side channel 60c that is formed in the interior of the first side support member 60, a (2-2)-th side channel 70c that is formed in the interior of the second side support member 70, a (3-2)-th side channel 80c that is formed in the interior of the third side support member 80, a (4-2)-th side channel 90c that is formed in the interior of the fourth side support member 90, and a (5-2)-th side channel 100c that is formed in the interior of the fifth side support member 100.

Meanwhile, the cooling water may be introduced into the manifold block 40 through the introduction pipe 2. The cooling water introduced into the manifold block 40 may be distributed to the (1-1)-th to (5-1)-th side channels 60b to 100b through the introduced cooling water channel 40b and may flow in direction C1.

Thereafter, the cooling water may circulate from the (1-1)-th to (5-1)-th side channels 60b, 70b, 80b, 90b, and 100b and may be collected in the discharged cooling water channel 40c through the (1-2)-th to (5-2)-th side channels 60c, 70c, 80c, 90c, and 100c.

The cooling water collected in the discharged cooling water channel 40c may be discharged to an outside of the battery housing 10 through the discharge pipe 3. Then, the cooling water may be understood as flowing in direction C2 through the second cooling water channel 30c.

Hereinafter a detailed structure of the battery housing 10 according to an embodiment of the present disclosure will be described.

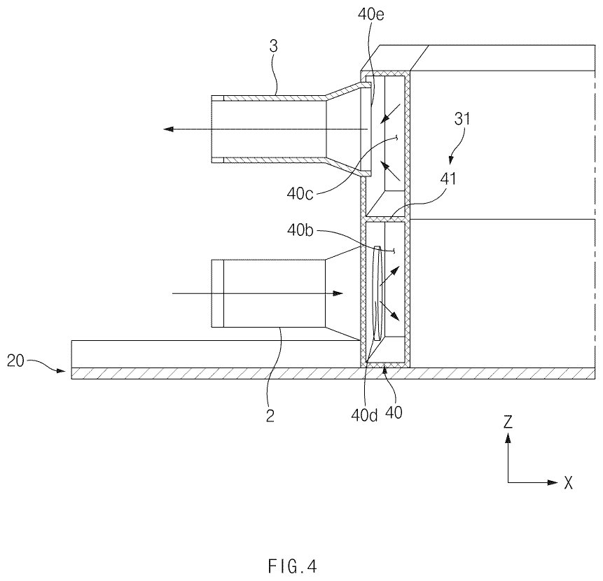

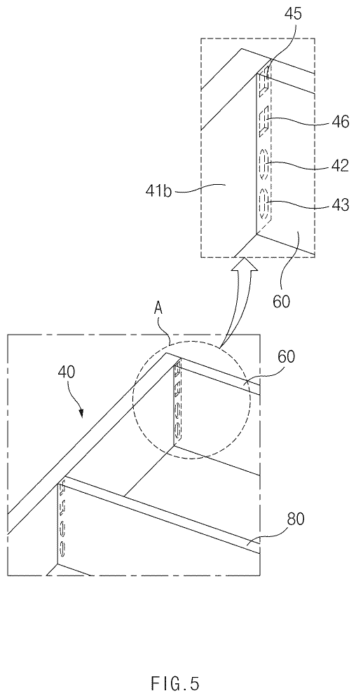

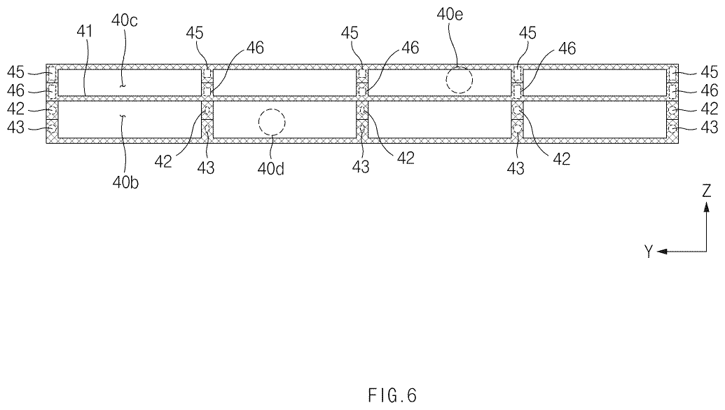

FIG. 3 is an enlarged view of the manifold block of the battery housing and surrounding components according to an embodiment of the present disclosure. FIG. 4 is a vertical cross-sectional view of the manifold block and the surrounding components according to an embodiment of the present disclosure. FIG. 5 is a diagram illustrating a distribution hole that is provided on a rear surface of the manifold block according to an embodiment of the present disclosure. FIG. 6 is a cross-sectional view illustrating the introduced cooling water channel, the discharged cooling water channel, and the plurality of distribution holes of the manifold block according to an embodiment of the present disclosure.

Referring to FIGS. 3 to 6, in the battery housing 10, the cooling water may be introduced into the first cooling water channel 30b through the introduction pipe 2 as described above. The first cooling water channel 30b may be communicated with the introduction hole 40d, through which the cooling water is introduced into the support member 30. The introduction hole 40d may be at a position that is coupled to the introduction pipe 2.

Meanwhile, the second cooling water channel 30c may be communicated with the discharge hole 40e, through which the cooling water is discharged from the support member 30, and may be provided on an upper side (the “Z” direction) of the first cooling water channel 30b. The discharge hole 40e may be at a position that is coupled to the discharge pipe 3. That is, the manifold block 40 may define the introduction hole 40d and the discharge hole 40e.

The introduction hole 40d and the first cooling water channel 30b may be disposed on a lower side (an opposite direction to the “Z” direction) of the discharge hole 40e and the second cooling water channel 30c. According to this structure, the cooling water that is introduced into the support member 30 through the introduction hole 40d may flow toward the second direction (the “X” direction) of the battery module 5 (see FIG. 2) and then may circulate and flow through the second cooling water channel 30c toward an opposite direction to the second direction (an opposite direction to the “X” direction) of the battery module 5.

Meanwhile, in the case of a structure in which the first cooling water channel and the second cooling water channel extend horizontally in parallel to each other to be connected, a deviation of cooling effects between an area of the battery module that is cooled by the first cooling water channel and an area of the battery module that is cooled by the second cooling water channel may be relatively high.

On the other hand, according to the structure according to an embodiment of the present disclosure, the first cooling water channel 30b and the second cooling water channel 30c are provided in a vertical direction whereby the deviation in the cooling effects depending on the position of the battery module 5 may be relatively reduced, and thus, a performance of the battery module 5 may be maintained.

Furthermore, when the second cooling water channel 30c is located on an upper side (the “Z” direction) of the first cooling water channel 30b, the flow of the cooling water from the first cooling water channel 30b to the second cooling water channel 30c due to the difference in density of the cooling water depending on different temperatures may be smoothly made. In other words, a temperature of the cooling water that flows through the first cooling water channel 30b may be relatively lower than a temperature of the cooling water that flows through the second cooling water channel 30c, and the cooling water that flows through the first cooling water channel 30b may circulate in the second cooling water channel 30c more smoothly than in the case in which the second cooling water channel 30c is on a lower side (an opposite to the “Z” direction) of the first cooling water channel 30b. Due to this, the circulation of the cooling water that flows in an interior of the support member 30 may be smooth.

The support member 30 may include a partition wall 31 that extends horizontally to separate the first cooling water channel 30b and the second cooling water channel 30c.

The partition walls 31 may extend horizontally in parallel to each other between an upper end of the support member 30 and a lower end of the support member 30 to vertically space the first cooling water channel 30b and the second cooling water channel 30c apart from each other. The partition wall 31 may prevent the cooling water that flows through the first cooling water channel 30b and the cooling water that flows through the second cooling water channel 30c from being mixed with each other.

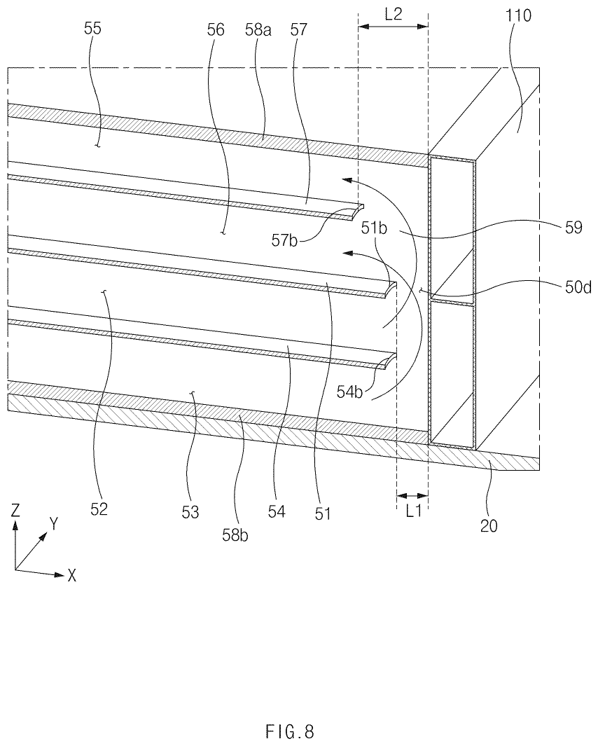

The partition wall 31 may include a manifold partition wall 41 that is provided in an interior of the manifold block 40 and a side partition wall 51 (see FIG. 8) that is provided in an interior of the side support member 50. The manifold partition wall 41 may extend in the first direction (the “Y” direction), and the side partition wall 51 may extend in the second direction (the “X” direction).

Meanwhile, the cooling water that is introduced into the introduced cooling water channel 40b needs to be distributed to the first circulating cooling water channel 50b provided in the interior of each of the side support members 50 or the cooling water needs to be collected in the discharged cooling water channel 40c from the second circulating cooling water channel 50c. To achieve this, the distribution holes 42, 43, 45, and 46 may be provided on a rear surface 41b of the manifold block 40. The distribution holes 42, 43, 45, and 46 may have a shape that is opened in an opposite direction to the introduction hole 40d and the discharge hole 40e on a rear surface 41b of the front surface 41a on which the introduction hole 40d and the discharge hole 40e are formed. The shapes of the distribution holes 42, 43, 45, and 46 are not limited to those illustrated in the drawings.

The distribution holes 42, 43, 45, and 46 may include first distribution holes 42 and 43 that communicate the introduced cooling water channel 40b and the first circulating cooling water channels 50b and second distribution holes 45 and 46 that communicate the discharged cooling water channel 40c and the second circulating cooling water channels 50c.

Meanwhile, the first circulating cooling water channel 50b may include a (1-1)-th circulating cooling water channel 52 and a (1-2)-th circulating cooling water channel 53 that is located on a lower side (an opposite direction to the “Z” direction) of the (1-1)-th circulating cooling water channel 52. Accordingly, the (1-1)-th circulating cooling water channel 52 and the (1-2)-th circulating cooling water channel 53 may be partitioned from each other.

Furthermore, the second circulating cooling water channel 50c may include a (2-1)-th circulating cooling water channel 55 and a (2-2)-th circulating cooling water channel 56 that is located on a lower side (an opposite direction to the “Z” direction) of the (2-1)-th circulating cooling water channel 55. Accordingly, the (2-1)-th circulating cooling water channel 55 and the (2-2)-th circulating cooling water channel 56 may be partitioned from each other.

In more detail, the cooling water may be distributed from the introduced cooling water channel 40b to the (1-1)-th circulating cooling water channel 52 and the (1-2)-th circulating cooling water channel 53, respectively, and the cooling water may be collected from the (2-1)-th circulating cooling water channel 55 and the (2-2)-th circulating cooling water channel 56 in the discharged cooling water channel 40c.

To achieve this, the first distribution holes 42 and 43 may include a (1-1)-th distribution hole 42 that communicates the introduced cooling water channel 40b and the (1-1)-th circulating cooling water channel 52 and a (1-2)-th distribution hole 43 that communicates the introduced cooling water channel 40b and the (1-2)-th circulating cooling water channel 53. The (1-2)-th distribution hole 43 may be located on a lower side (an opposite direction to the “Z” direction) of the (1-1) distribution hole 42.

Furthermore, the second distribution holes 45 and 46 may include a (2-1)-th distribution hole 45 that communicates the discharged cooling water channel 40c and the (2-1)-th circulating cooling water channel 55 and a (2-2)-th distribution hole 46 that communicates the discharged cooling water channel 40c and the (2-2)-th circulating cooling water channel 56. The (2-2)-th distribution hole 45 may be located on a lower side (an opposite direction to the “Z” direction) of the (2-1)-th distribution hole 46.

As described above, a plurality of (1-1)-th distribution holes 42, a plurality of (1-2)-th distribution holes 43, a plurality of (2-1)-th distribution holes 45, and a plurality of (2-2)-th distribution holes 46 may be provided. Each of the (1-1)-th distribution hole 42 and the (1-2)-th distribution hole 43 may have a cross-section that is perpendicular to a direction in which cooling water flows and which becomes smaller as it comes closer to the introduction hole 40d. Each of the (2-1)-th distribution hole 45 and the (2-2)-th distribution hole 46 may have a cross-section that is perpendicular to the direction in which cooling water flows and which becomes smaller as it comes closer to the discharge hole 40e.

In the structure, because an intensity of a flow pressure of the cooling water may become stronger as it comes closer to the introduction hole 40d and the discharge hole 40e, the cooling water may be smoothly distributed to the first circulating cooling water channel 50b and the second circulating cooling water channel 50c.

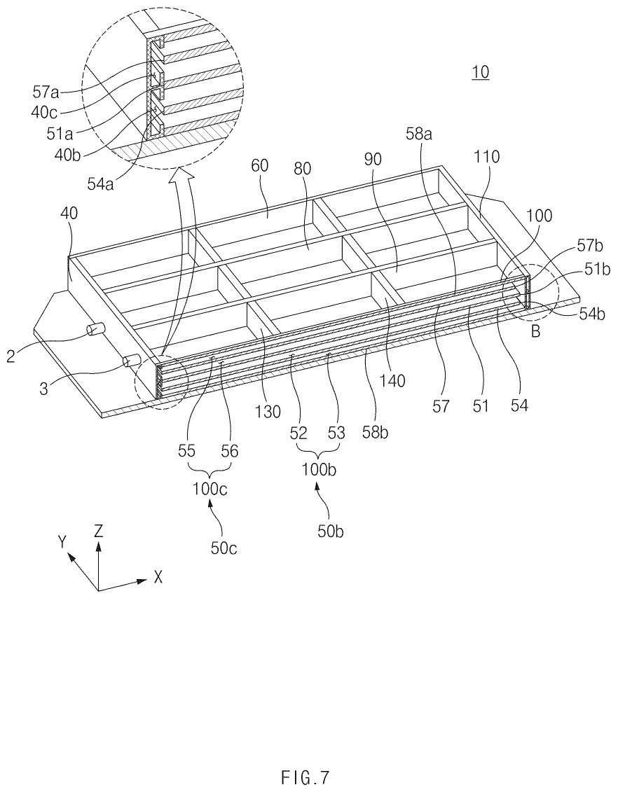

Hereinafter, the (5-1)-th side channel 100b and the (5-2)-th side channel 100c that are formed in an interior of the fifth side support member 100 will be described with reference to FIGS. 7 and 8. However, it may be understood that the first to fourth side support members 60 to 90 correspond to the structure of the fifth side support member 100.

FIG. 7 is a perspective view illustrating a vertical cross-section of the fifth side support member according to an embodiment of the present disclosure. FIG. 8 is an enlarged view of portion “B” illustrated in FIG. 7. Meanwhile, the contents regarding the fifth side support member, which will be described later with reference to FIGS. 7 and 8, may be applied to the first to fourth side support members in the same way.

Referring to FIGS. 7 and 8, one side of the fifth side support member 100 may be connected to the manifold block 40 and an opposite side thereof may be connected to the end member 110.

In an interior of the fifth side support member 100, a first circulating cooling water channel 50b that is configured to distribute the cooling water from the introduced cooling water channel 40b of the manifold block 40 and a second circulating cooling water channel 50c that is configured such that the cooling water flows after circulating from the first circulating cooling water channel 50b may be provided.

Meanwhile, the first circulating cooling water channel 50b of the fifth side support member 100 may be understood as the (5-1)-th side channel 100b and the second circulating cooling water channel 50c of the fifth side support member 100 may be understood as the (5-2)-th side channel 100c.

The first circulating cooling water channel 50b of the fifth side support member 100 may include a (1-1)-th circulating cooling water channel 52 and a (1-2)-th circulating cooling water channel 53, and the second circulating cooling water channel 50c may include a (2-1)-th circulating cooling water channel 55 and a (2-2)-th circulating cooling water channel 56.

The fifth side support member 100 may include a side partition wall 51 that is provided in an interior of the fifth side support member 100 to separate the first circulating cooling water channel 50b and the second circulating cooling water channel 50c and extends in the second direction (the “X” direction).

The side partition wall 51 may include one end 51a that is connected to the manifold block 40 and an opposite end 51b that is disposed on an opposite side of the one end 51a and is spaced apart from the end member 110. The opposite end 51b of the side partition wall 51 may be spaced apart from the end member 110 and may define a circulation hole 50d that connects the first cooling water channel 30b and the second cooling water channel 30c together with the end member 110.

That is, the fifth side support member 100 may include a circulation hole 50d that is provided at the opposite end 51b of the side partition wall 51 and connects the (1-1)-th circulating cooling water channel 52 and the (1-2)-th circulating cooling water channel 53 and the (2-1)-th circulating cooling water channel 55 and the (2-2)-th circulating cooling water channel 56.

Meanwhile, the fifth side support member 100 may include a first guide partition wall 54 that is disposed to be parallel to the side partition wall 51 and spaced apart from the side partition wall 51 to separate the (1-1)-th circulating cooling water channel 52 and the (1-2)-th circulating cooling water channel 53 and a second guide partition wall 57 that is disposed to be parallel to the side partition wall 51 and spaced apart from the side partition wall 51 to separate the (2-1)-th circulating cooling water channel 55 and the (2-2)-th circulating cooling water channel 56.

The first guide partition wall 54 may be disposed on a lower side (an opposite direction to the “Z” direction) of the side partition wall 51, and the second guide partition wall 57 may be disposed on an upper side (the “Z” direction) of the side partition wall 51.

Due to this structure, a (1-1)-th circulating cooling water channel 52 may be formed between the first guide partition wall 54 and the side partition wall 51, and a (1-2)-th circulating cooling water channel 53 may be formed between the first guide partition wall 54 and the lower wall 58b of the fifth side support member 100. Furthermore, a (2-1)-th circulating cooling water channel 55 may be formed between the second guide partition wall 57 and the upper wall 58a of the side support member 50, and a (2-2)-th circulating cooling water channel 56 may be formed between the second guide partition wall 57 and the side partition wall 51.

Then, a distance L2 in the second direction (the “X” direction) between the second guide partition wall 57 and the end member 110 may be formed to be greater than a distance L1 in the second direction (the “X” direction) between the first guide partition wall 54 and the side partition wall 51 and the end member 110.

This structure may be a structure for relatively uniformly distributing the cooling water that circulates from the (1-1)-th circulating cooling water channel 52 and the (1-2)-th circulating cooling water channel 53 to the (2-1)-th circulating cooling water channel 55 and the (2-2)-th circulating cooling water channel 56.

In other words, in the structure, in which the distance L2 between the second guide partition wall 57 and the end member 110 corresponds to the distance L1 between the first guide partition wall 54 and the end member 110 or the distance L1 between the side partition wall 51 and the end members 110, the cooling water that circulates to the (2-1)-th circulating cooling water channel 55 from the (1-1)-th circulating cooling water channel 52 and the (1-2)-th circulating cooling water channel 53 may be less than the cooling water that circulates to the (2-2)-th circulating cooling water channel 56. In this case, because a deviation in the cooling effects of the battery module 5 (see FIG. 2) depending on a height to an upper side (the “Z” direction) may occur, amounts of the cooling water that are introduced into the (2-1)-th circulating cooling water channel 55 and the (2-2)-th circulating cooling water channel 56 needs to be uniformly distributed.

Accordingly, according to an embodiment of the present disclosure, the distance L2 between the second guide partition wall 57 and the end member 110 may be formed to be greater than the distance L1 between the first guide partition wall 54 and the side partition wall 51 and the end member 110, whereby amounts of the cooling water that are introduced into and flow into the (2-1)-th circulating cooling water channel 55 and the (2-2)-th circulating cooling water channel 56 may be relatively distributed. Accordingly, a variation in the cooling effects of the battery module 5 depending on a height thereof may be reduced.

Furthermore, the distance L1 between the first guide partition wall 54 and the end member 110 may be formed to correspond to the distance L1 between the side partition wall 51 and the end member 110.

Furthermore, the opposite end 51b of the side partition wall 51, the opposite end 54b of the first guide partition wall 54, and the opposite end 57b of the second guide partition wall 57 may have a shape that is recessed toward the manifold block 40.

For example, the opposite end 51b of the side partition wall 51, the opposite end 54b of the first guide partition wall 54, and the opposite end 57b of the second guide partition wall 57 may be formed to be spaced apart from the end member 110 farther as they become farther from the pair of inner surfaces 59 that extend in the second direction (the “X” direction) to connect an upper wall 58a and a lower wall 58b of the fifth side support member 100.

Even with this structure, the cooling water may smoothly circulate from the (1-1)-th circulating cooling water channel 52 and the (1-2)-th circulating cooling water channel 53 to the (2-1)-th circulating cooling water channel 55 and the (2-2)-th circulating cooling water channel 56. Accordingly, the cooling effect of the battery module 5 may be improved due to the smooth circulation of the cooling water.

Meanwhile, the cooling water introduced into the (2-1)-th circulating cooling water channel 55 and the (2-2)-th circulating cooling water channel 56 may flow in an opposite direction to the second direction (the “X” direction) and may be collected in the discharged cooling water channel 40c and discharged to an outside through the discharge pipe 3.

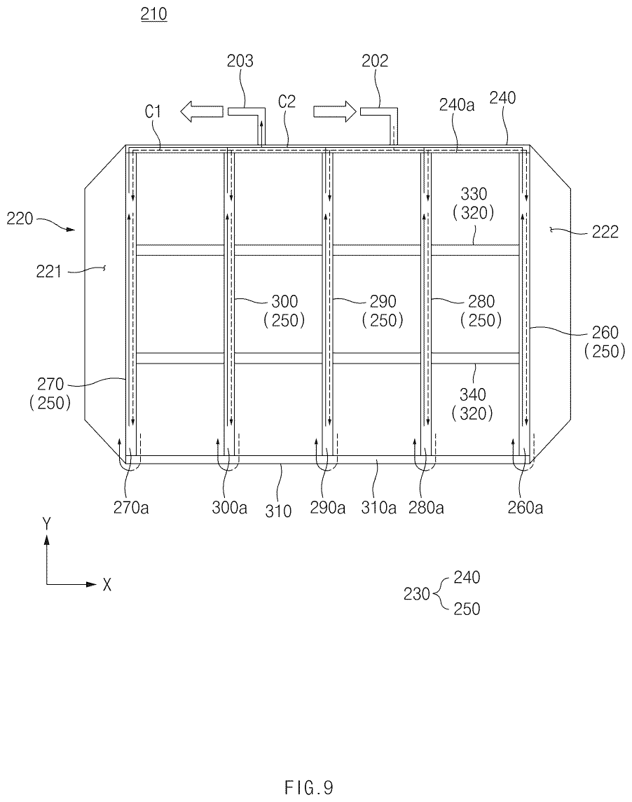

FIG. 9 is a schematic view illustrating a flow of the cooling water that flows through the battery housing according to another embodiment of the present disclosure.

According to FIG. 9, it may be understood as having a structure in which the flow direction of the cooling water is different from that of the battery housing 10 according to an embodiment of the present disclosure described above.

In more detail, according to another embodiment of the present disclosure, the battery housing 210 may include a base plate 220, a support member 230 that is supported by the base plate 220, and an end member 310.

The support member 230 may include a manifold block 240 that extends in a lengthwise direction of the battery housing 210 and is disposed to face one side of the battery housing 210. An introduction pipe 202 and a discharge pipe 203 may be formed on one surface of the manifold block 240. Then, the manifold block 240 may extend in the above-described second direction (the “X” direction).

The support member 230 may include a side support member 250 that extends from the manifold block 240 in an opposite direction to the first direction (the “Y” direction) that is perpendicular to the second direction (the “X” direction). The side support member 250 may extend from the manifold block 240 toward the end member 310.

The side support member 250 may include a first side support member 260 and a second side support member 270, which are disposed in parallel to each other, and a third side support member 280, a fourth side support member 290, and a fifth side support member 300, which are disposed between the first side support member 260 and the second side support member 270.

The end member 310 may be disposed in parallel to the manifold block 240. The end member 310 may be disposed in parallel with the manifold block 240, may be connected to the side support member 250, and may be configured to face the manifold block 240 while the side support member 250 is interposed therebetween.

Electric part accommodating parts 221 and 222 for electric parts (not illustrated) for controlling the battery module may be provided on a front side (an opposite direction to the “X” direction) of the second side support member 270 or a rear side (the “X” direction) of the first side support member 260.

Furthermore, the partition member 320 may extend in the second direction (the “X” direction) to cross the side support member 250.

The cooling water channels formed inside the support member 230 may include a manifold channel 240a that is defined by the manifold block 240 and first to fifth side channels 260a, 270a, 280a, 290a, and 300a that are communicated with the manifold channel 240a, respectively, and are formed in interiors of the side support members 250, respectively.

The cooling water introduced through the introduction pipe 202 may flow through the introduced cooling water channel formed in an interior of the manifold block 240. Thereafter, the cooling water may flow in an opposite direction to the first direction (the “Y” direction) through the first circulating cooling water channel that is formed in an interior of each of the side support members 250.

The cooling water that flows through the first cooling water channel may circulate to the second circulating cooling water channel formed in an interior of each of the side support members 250 and flow in the first direction (the “Y” direction).

Thereafter, the cooling water may be collected in the discharged cooling water channel formed in the interior of the manifold block 240. The cooling water collected in the discharged cooling water channel may be discharged to an outside of the battery housing 210 through the discharge pipe 3.

A relationship between the first cooling water channel and the second cooling water channel may correspond to that described in FIG. 2.

This technology may prevent the cooling effect from being reduced by the external environment by providing the cooling water channels to cool the battery module in the support member disposed on a side of the battery module.

Furthermore, in this technology, by disposing the first cooling water channel on a lower side of the second cooling water channel, the deviation in the cooling effects of the battery module may be reduced and the cooling effects of the battery module may be improved.

In addition, in this technology, the cooling water may circulate smoothly from the first cooling water channel to the second cooling water channel whereby the cooling effect of the battery module may be improved.

In addition, various effects that can be directly or indirectly recognized through this document may be provided.

The above description is a simple exemplary description of the technical spirits of the present disclosure, and an ordinary person in the art, to which the present disclosure pertains, may make various corrections and modifications without departing from the essential characteristics of embodiments of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery housing comprising:
a base plate disposed on a lower side of a battery module and configured to support the battery module; and
a support member supported by the base plate to define an accommodation space for accommodating the battery module and defining a cooling water channel in which cooling water configured to cool the battery module flows in an interior thereof, wherein the cooling water channel comprises:
a first cooling water channel communicated with an introduction hole through which the cooling water flows into the support member; and
a second cooling water channel communicated with a discharge hole through which the cooling water flowing in the first cooling water channel is discharged from the support member after circulating, wherein the second cooling water channel is disposed on an upper side of the first cooling water channel.

2. The battery housing of claim 1, wherein the support member comprises a partition wall separating the first cooling water channel and the second cooling water channel.

3. The battery housing of claim 2, wherein the partition wall extends in parallel to a horizontal direction between an upper end of the support member and a lower end of the support member.

4. The battery housing of claim 2, wherein the support member comprises:
a manifold block defining the introduction hole and the discharge hole and extending in a first direction; and
a side support member connected to the manifold block and extending in a second direction perpendicular to the first direction.

5. The battery housing of claim 4, wherein:
the first cooling water channel comprises an introduced cooling water channel defined by the manifold block and a first circulating cooling water channel communicated with the introduced cooling water channel and defined by the side support member; and
the second cooling water channel comprises a discharged cooling water channel defined by the manifold block and a second circulating cooling water channel communicated with the first circulating cooling water channel and defined by the side support member.

6. The battery housing of claim 4, wherein the partition wall comprises:
a manifold partition wall disposed in an interior of the manifold block and extending in the first direction; and
a side partition wall disposed in an interior of the side support member and extending in the second direction.

7. The battery housing of claim 6, wherein the side support member defines a circulation hole disposed at a second end opposite a first end of the side partition wall connected to the manifold block, the circulation hole connecting the first cooling water channel and the second cooling water channel.

8. The battery housing of claim 7, further comprising an end member disposed in parallel to the manifold block, connected to the side support member, and facing the manifold block in a state in which the side support member is interposed therebetween.

9. The battery housing of claim 8, wherein the side partition wall comprises a first end connected to the manifold block and a second end opposite the first end, the second end being spaced apart from the end member and defining the circulation hole together with the end member.

10. The battery housing of claim 9, wherein the second end of the side partition wall has a shape recessed toward the manifold block.

11. The battery housing of claim 4, further comprising a partition member supported by the base plate and extending in the first direction to cross the side support member so as to define the accommodation space.

12. A battery housing comprising:
a base plate disposed on a lower side of a battery module and configured to support the battery module; and
a support member comprising:
a partition wall;
a manifold block extending in a first direction and defining an introduction hole and a discharge hole disposed on a first surface, the manifold block comprising a first distribution hole disposed on a second surface opposite the first surface and a second distribution hole; and
a side support member connected to the manifold block and extending in a second direction perpendicular to the first direction, wherein the support member is supported by the base plate to define an accommodation space for accommodating the battery module and defining a cooling water channel in which cooling water configured to cool the battery module flows in an interior thereof, wherein the cooling water channel comprises:
a first cooling water channel communicated with the introduction hole through which the cooling water flows into the support member, the first cooling water channel comprising an introduced cooling water channel defined by the manifold block and a first circulating cooling water channel communicated with the introduced cooling water channel and defined by the side support member, wherein the first distribution hole communicates the introduced cooling water channel and the first circulating cooling water channel; and
a second cooling water channel disposed on an upper side of the first cooling water channel and communicated with the discharge hole through which the cooling water flowing in the first cooling water channel is discharged from the support member after circulating, the second cooling water channel comprising a discharged cooling water channel defined by the manifold block and a second circulating cooling water channel communicated with the first circulating cooling water channel and defined by the side support member, wherein the second distribution hole communicates the discharged cooling water channel and the second circulating cooling water channel, and wherein the partition wall separates the first cooling water channel and the second cooling water channel.

13. The battery housing of claim 12, wherein:
the first distribution hole is provided in plural and the second distribution hole is provided in plural;
sizes of cross-sections of the plurality of first distribution holes that are perpendicular to a direction in which the cooling water flows are progressively smaller as they approach the introduction hole; and
sizes of cross-sections of the plurality of second distribution holes that are perpendicular to the direction in which the cooling water flows are progressively smaller as they approach the discharge hole.

14. The battery housing of claim 12, wherein the partition wall comprises:
a manifold partition wall disposed in an interior of the manifold block and extending in the first direction; and
a side partition wall disposed in an interior of the side support member and extending in the second direction.

15. The battery housing of claim 14, wherein:
the first circulating cooling water channel comprises a (1-1)-th circulating cooling water channel and a (1-2)-th circulating cooling water channel distinguished from the (1-1)-th circulating cooling water channel; and
the second cooling water channel comprises a (2-1)-th circulating cooling water channel and a (2-2)-th circulating cooling water channel distinguished from the (2-1)-th circulating cooling water channel.

16. The battery housing of claim 15, wherein the side support member further comprises:
a first guide partition wall that is parallel to, and spaced apart from, the side partition wall to separate the (1-1)-th circulating cooling water channel and the (1-2)-th circulating cooling water channel; and
a second guide partition wall that is parallel to, and spaced apart from, the side partition wall to separate the (2-1)-th circulating cooling water channel and the (2-2)-th circulating cooling water channel.

17. The battery housing of claim 16, further comprising an end member disposed in parallel to the manifold block, connected to the side support member, and facing the manifold block in a state in which the side support member is interposed therebetween.

18. The battery housing of claim 17, wherein a first distance between the second guide partition wall and the end member is greater than a second distance between the first guide partition wall and the end member.

19. The battery housing of claim 17, wherein a first distance between the second guide partition wall and the end member is greater than a second distance between the side partition wall and the end member.

20. The battery housing of claim 17, wherein a first distance between the first guide partition wall and the end member corresponds to a second distance between the side partition wall and the end member.
